(19) United States
(12) Patent Application Publication
(10) Pub. No.: US 2021/0377580 A1
(43) Pub. Date: Dec. 2, 2021

(54) LIVE OR LOCAL ENVIRONMENTAL AWARENESS

(71) Applicant: AT&T Intellectual Property I, L.P., Atlanta, GA (US)

(72) Inventors: Mehdi Malboubi, San Ramon, CA (US); Baofeng Jiang, Pleasanton, CA (US); Laurie Bigler, Lafayette, CA (US)

(21) Appl. No.: 16/885,399

(22) Filed: May 28, 2020

(51) Int. Cl. H04N 21/234; H04N 21/2187; H04N 21/44; H04N 5/445; H04N 21/482; H04N 21/472; H04W 4/90

(52) U.S. Cl. CPC H04N 21/23418; H04N 21/2187; H04N 21/44008; H04W 4/90; H04N 21/482; H04N 21/47214; H04N 5/44582

(57) ABSTRACT

A system may collect data from different sources, process and fuse the data, and distribute the processed or fused data to user devices in a near-real time manner. In an example, a processor may effectuates operations that include operations, such as receiving information from a plurality of devices at a location during a period, the information may include electronic media and location information, wherein the location information corresponds to where the electronic media was created; fusing the information from the plurality of devices, wherein the fusing includes superimposing the electronic media of the plurality of devices, wherein the electronic media includes images, video, or audio; anonymizing the fused information, wherein the anonymizing includes replacing people in the electronic media with an icon; receiving a request for an image, video, or audio associated with the location and the period; and in response to the request, providing the anonymized fused information corresponding to the location and the period.

### BACKGROUND

Information, such as video, audio, still images, or sensor information may be captured by different devices including sensor-enabled drones, sensor-enabled smart phones, satellites, road traffic monitoring cameras, or security cameras. Conventionally the information is kept in the memory of the device that captured the information, on a cloud device that may store back-ups of the information, or posted on social media.

This background information is provided to reveal information believed by the applicant to be of possible relevance. No admission is necessarily intended, nor should be construed, that any of the preceding information constitutes prior art.

### SUMMARY

Disclosed herein is a framework for collecting data from different sources, processing the data, and distributing the processed data. In an example, a system may include one or more processors and memory coupled with the one or more processors that effectuates operations. The operations may include receiving information from a plurality of devices at a location during a period, the information including electronic multimedia and location information, wherein the location information corresponds to where the electronic multimedia was created; fusing the information from the plurality of devices; anonymizing the fused information, wherein the anonymizing includes replacing a live object in the electronic multimedia with a representative icon; receiving a request for an image, video, or audio associated with the location and the period; and in response to the request, providing the anonymized fused information corresponding to the location and the period. Analytics may be used to determine where to locally store or process the information

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for live or local environmental awareness.

FIG. 2 illustrates an exemplary method for live or local environmental awareness.

FIG. 3 illustrates an exemplary method for live or local environmental awareness.

FIG. 4 illustrates an exemplary framework for live or local environmental awareness.

FIG. 5 illustrates a schematic of an exemplary network device.

FIG. 6 illustrates an exemplary communication system that provides wireless telecommunication services over wireless communication networks.

FIG. 7A is a representation of an exemplary network.

FIG. 7B is a representation of an exemplary hardware platform for a network.

### DETAILED DESCRIPTION

Live or local environmental awareness as disclosed herein may be used for different services, from everyday commute scenarios with regard to fine-grained local road traffic information, to emergency situations where live or local environmental awareness may be a feature used for reconstructing accident scenes in order to save lives or reduce damage to property. Live or local environmental awareness applications may access a variety of sources of information and have the capability to process and fuse different sources of information. Disclosed herein are system, methods, and apparatus for collecting data from different sources, fusing the data, and distributing the fused data.

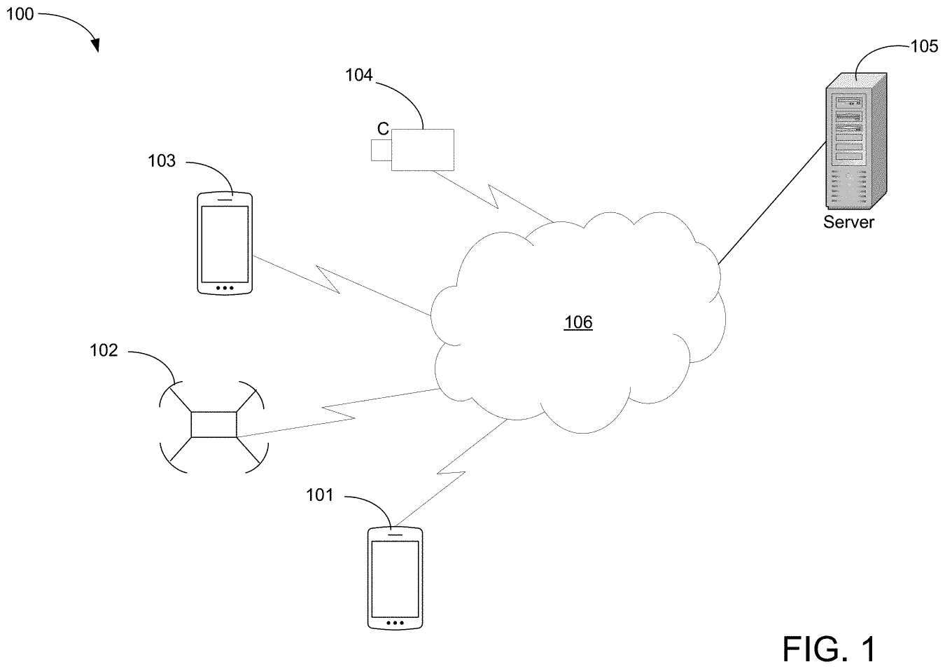

FIG. 1 illustrates an exemplary system for live or local environmental awareness. System 100 may include network 106, mobile device 101, unmanned vehicle (UV) 102, mobile device 103, sensor 104, edge device 107, edge device 108, or edge device 109. The devices of system 100 may be communicatively connected with each other and network 106 (e.g., a cloud network). Mobile device 101 and mobile device 103 may include a laptop, tablet, autonomous vehicle (e.g., SAE Intl level 3 to level 5 automation), or mobile phone, among other things. UV 102 may include an aerial, a ground, or a water-based vehicle. Sensor 104 may include vehicular cameras, building security cameras, or traffic cameras, among other cameras. Sensor 104 may also include temperature sensors, gas sensors, chemical sensors, smoke sensors, infrared sensors, image sensors (e.g., charge-coupled device, or complementary metal-oxide semiconductor imagers), motion sensors, accelerometer sensors, gyroscope sensors, optical sensor, or the like. Server 105 may obtain information (e.g., multimedia information or sensor information) from the plurality of devices of system 100 and fuse the information. The fused information may be analyzed and used for mapping applications, identifying or reconstructing accidents, or gathering statistical information (e.g., demographics of an area), among other things in a near real-time manner. Edge device 107—edge device 109 may store or process information, such as the fused information. As disclosed herein, analytics may be used to determine where to locally store or process the information.

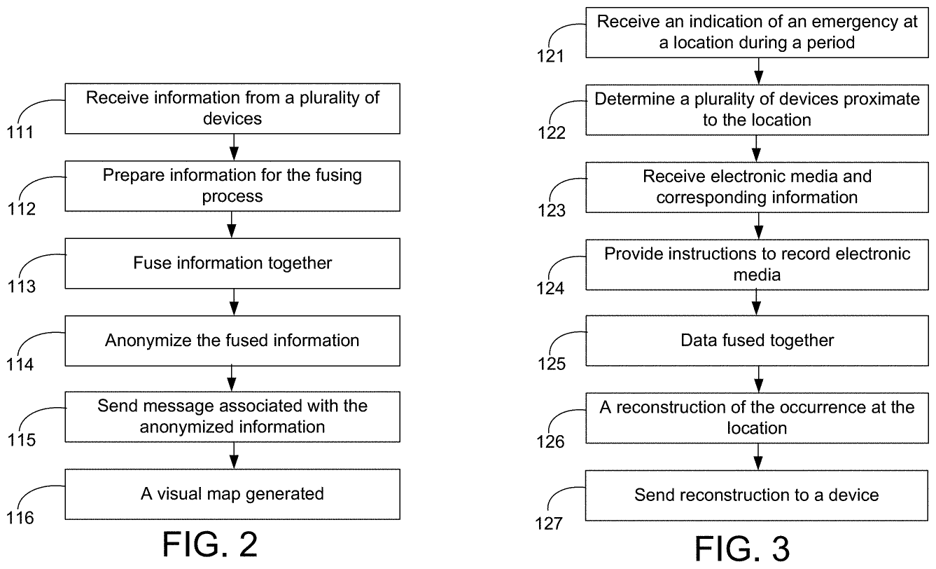

FIG. 2 illustrates an exemplary method for live or local environmental awareness. At step 111, server 105 may receive information from a plurality of devices of system 100 (e.g., mobile device 101, UV 102, mobile device 103, or sensor 104) that may be enabled to record video, record audio, take photos, or collect sensor information (e.g., sensor observations or sensor measurements). The information may include electronic media (e.g., video, audio, images, or sensor information) and corresponding location and other descriptive information for the electronic media. The location information may be obtained via GPS, triangulation, or extrapolation based on known locations of landmarks (e.g., a statue or streetscape) in images, among other things. In an example, with regard to extrapolation, the location may be determined based on detecting an object in the electronic media and cross-referencing a previously known location of the object, which may already be in a database. Location may correspond to the location of mobile device 101 when the electronic media was captured by mobile device 101. Users of the plurality of devices may opt-in to allow access to their data. In exemplary scenarios, this access may be allowed based on the following: 1) without a fee to the user, 2) in exchange for free or discounted services, 3) purchased from the user when used in a service (e.g., navigation service, live television or other video service, or telemedicine service), or the like. It is contemplated that appropriate data privacy and data security measures would be taken before or after receiving the information of step 111.

With continued reference to FIG. 2, at step 112, the information of step 111 may be processed to prepare it for the fusing process. The processing may include filtering electronic media (e.g., images, videos, or audio) of step 111 to enhance the quality, in which techniques may be used for dealing with not a number (NaN), noisy values, or missed values. Other processing may include registering the electronic media, segmenting the electronic media, compressing the electronic media, registering the electronic media, recognizing objects in electronic media, altering the electronic media to adhere to a standard format (e.g., high definition 1080p), or incorporating auxiliary information by adding text or labeling scenes. The processing may occur before or after server 105 receives the information.

With continued reference to FIG. 2, at step 113, the information of step 111 may be fused together. In an exemplary scenario, during a relevant period (e.g., a 60 second time frame) at a relevant location (e.g., covering a radius of 50 feet from a GPS coordinate), there may be a plurality of devices of system 100 that has captured electronic media for some or part of the location during the period. In this example, mobile device 101 may primarily capture audio at the location. UV 102 may capture video of vehicle traffic at the location. Mobile device 103 may primarily capture phots of landscape (e.g., trees and grass) at the location. And sensor 104 (e.g., a security camera) may primarily capture video of live objects (e.g., people) on the sidewalk at the location. It is contemplated that some parts of the electronic media of a first device will overlap with a second device (e.g., both devices may capture an image of the same tree at different angles). Pattern recognition and electronic media segmentation techniques may be used to fuse (e.g., superimpose or overlay) the electronic media (e.g., video, audio, or images). Computer vision techniques may be used to fuse the electronic media as well. Computer vision is a field of artificial intelligence that trains computers to interpret and understand the visual world. Computer vision allows the use of digital images from cameras and videos and deep learning models, in a way that machines can accurately identify and classify objects—and then react to what they “see.” The fusing of electronic media in this step 113 may also include incorporating auxiliary information by adding texts or labeling scenes. Auxiliary information may include weather, traffic, pollution, or social-network information which may be provided from external sources. Fusing, for example, may include incorporating sensor information to indicate particular measurements or observations in an image or using to support interactive use of the electronic media (e.g., clicking a vehicle and getting speed and direction). Fusing may include superimposing or overlaying satellite images, aerial photography, mobile phone electronic media (photos, videos, or audio), or geographic information system (GIS) data.

With continued reference to FIG. 2, at step 114, server 105 may anonymize the fused information of step 113, wherein the anonymizing may include replacing vehicles, people, private areas (e.g., interior of homes), or the like in scenes with appropriate symbols, patterns, or icons. Video, image, facial, or audio (e.g., voice or music) recognition may be used to recognize the appropriate information (e.g., a particular image or audio coordinate) to be anonymized. This anonymization may help address data privacy or data security issues. It is contemplated that a user profile may allow for some information (e.g., the person in the accident) to not be anonymized.

With continued reference to FIG. 2, at step 115, a message (e.g., alert) may be sent about the anonymized information of step 114 or the fused information of step 113. The message may be sent based on a detected indication of an emergency (e.g., traffic accident or message to 911). The message may include a link to the anonymized or fused information which may be held in an application or website, may include electronic media (e.g., audio, image, or video), or text of at least some of the anonymized or fused information of step 114 or step 113. The information of step 114 or step 113 may be sent to applications for further processing in order to implement services in line with the application. In a first example, a network may be adapted (e.g., reconfigured) to support expanding or reducing resources to comply with quality of service (QoS). The resources may include virtual resources (e.g., virtual machines or virtual network functions), communication resources (e.g., wireline or wireless channels), compute resources, or the establishment of required network paths, which may be based on re-programming the underlying software defined network devices (e.g. switches or routers), among other resources.

With continued reference to FIG. 2, at step 116, a map may be generated using the anonymized information of step 114 or the fused information of step 113. The map may be available to be displayed on a targeted device upon request. The map may be superimposed images, video, audio, or sensor information at the location.

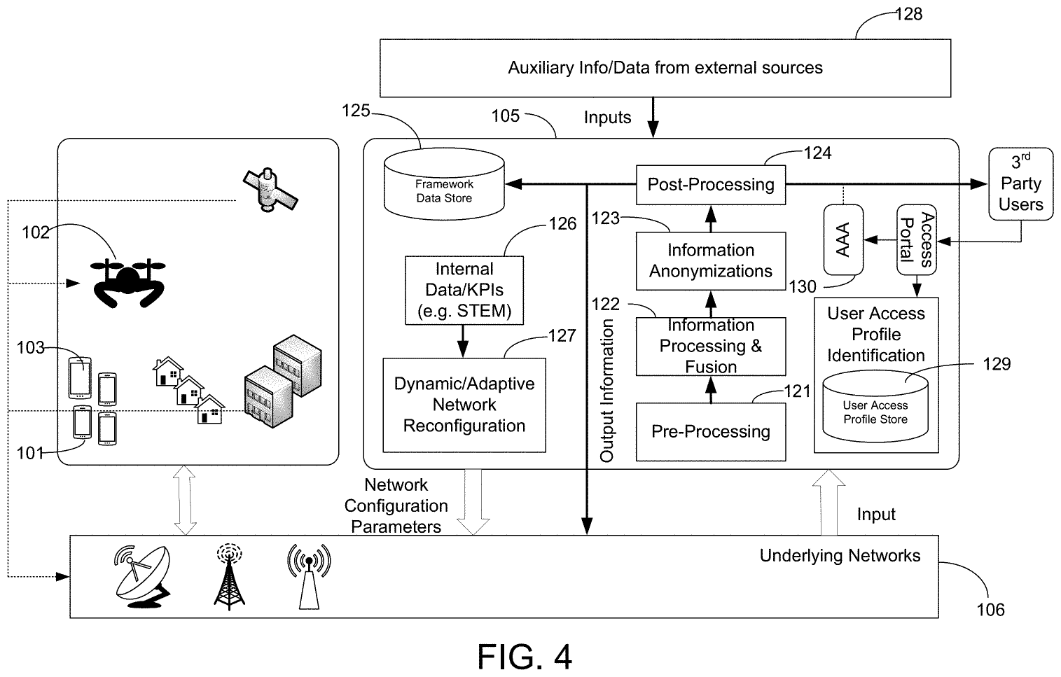

FIG. 3 illustrates an exemplary method for live or local environmental awareness for an emergency. At step 121, server 105 may receive an indication of an emergency at a location during a period. The indication of the emergency may be based on an indication of a communication to an emergency phone number (e.g., text or call to 911 or a security guard), an indication of a significant accident (e.g., air bag deployment indicated by a device), an indication of anticipated accident (e.g., a vehicle may be aware based on its braking or object avoidance system and send an alert), or an indication of a crime (e.g., computer vision detects a robbery or assault based on video from a security camera). At step 122, based on the indication of the emergency at the location, server 105 may determine a plurality of devices near the location (e.g., within 200 feet or within a viewing angle of the location). Data from the plurality of devices during a period may be marked at a high priority, therefore the processing of electronic media or traversal of electronic media across a communications network may be placed ahead of most other data.

With continued reference to FIG. 3, at step 123, server 105 may receive, which may be based on the indication of the emergency at the location, electronic media and corresponding information from the plurality of devices proximate to the location. The proximity may be determined based on the within a view angle of the location, determined based on the ability to identify a captured image, audio, or the like of the location, or within a latency or distance threshold. The receiving of the electronic media may be based on instructions that were provided to the plurality of devices to share electronic media and corresponding information during the period at the location. For example, UV 102, may have electronic media stored in memory that may have been scheduled to upload at some later time, but the immediate need based on the emergency may call for an immediate upload of the electronic media of UV 102. Although electronic media is disclosed herein, it is contemplated that sensor information in general and other information disclosed herein may be used.

At step 124, server 105 may provide instructions to record electronic media to at least a subset of the plurality of the devices. In an example, there may be mobile phones (e.g., mobile device 101) or traffic cameras (e.g., sensor 104) that may be asleep or otherwise not placed into a recording mode. In this example, mobile device 101 or sensor 104 may automatically record and obtain the electronic media. Mobile device 101 may receive a message for a user to indicate whether mobile device 101 will participate in recording during the period. Server 105, in response to step 124, may subsequently receive recorded electronic media for the period.

With continued reference to FIG. 3, at step 125, data (e.g., information of step 123 or step 124) may be fused together. At step 126, a reconstruction of the occurrence (e.g., emergency) at the location during the period may be generated. The reconstruction may be images, video, audio, or other electronic media (or sensor information) that provide actual footage which may be superimposed or simulated footage (e.g., images, video, audio, or text) of the occurrence. At step 127, the reconstruction of step 126 may be sent to a device. The device may be a device associated with public safety, insurance, or an injured party. An injured party may be a person or animal (e.g., a person cut) or property (e.g., damaged vehicle, sidewalk, or building). The reconstruction may help determine the resources (people or equipment) that should be dispatched to the emergency, may help determine the type of injuries to person or property (and therefore type of treatment needed), or may help determine the cause of the accident. There may be a determination of whether fire, police, or EMTs should be dispatched to the location and how many of each. The reconstruction or other information associated with the site may be used to inform hospitals so they may prepare for arrival of an injured party.

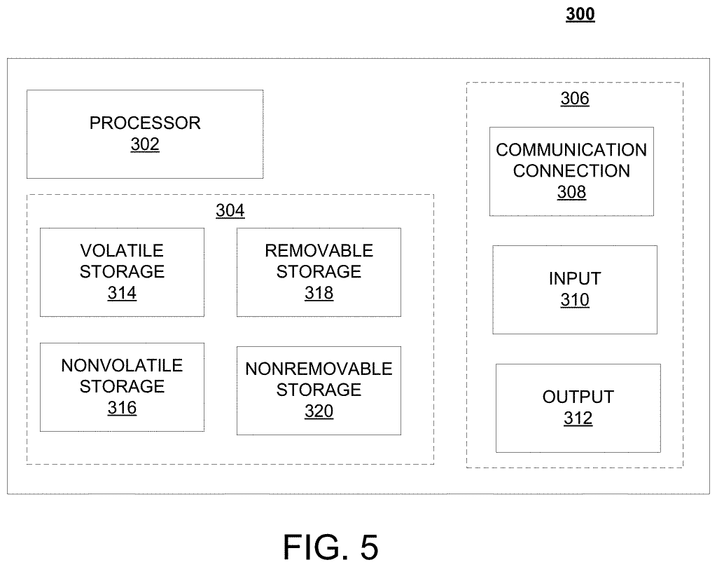

FIG. 4 illustrates an exemplary architectural block diagram associated with live or local environmental awareness. As shown in FIG. 4, network 106 may be an underlying network that may connect server 105 with communication devices, such as mobile device 101, UV 102, or mobile device 103. Server 105 may include pre-processing module 131, information processing and fusion module 132, anonymization module 133, post-processing module 134, framework data store 135, data store 136, reconfiguration module 137, or user access profile module 139, among others. Auxiliary information may be communicated to server 105 as shown in auxiliary information module 138. Pre-processing module 131 may include processing information for filtering input images, videos, or audio to enhance the quality, or applying techniques for dealing with NaN. Fusion module 132 may include processing information from different sources in order make a single image of a scene out of many. Anonymization module 133 may process private information (e.g., personally identifiable information). Post-processing module 134 may perform processing, such as resizing electronic media based on device type, adjusting frame rates, or compressing contents before storing in the framework data store and transmitting to users.

With continued reference to FIG. 4, reconfiguration module 137 may reconfigure the network infrastructure, such as network 106 (network devices and the configurations of network devices—e.g., edge device 107). The reconfiguration may include using, creating, or instantiating physical networks, virtual networks, or other resources that support the required QoS. In an example, reconfiguration may include allocating communication resources, allocating network resources, allocating compute resources, or establishing required network paths via re-programming the software defined network devices (e.g., switches or routers). Reconfiguration module 137 may receive information, such as key performance indicators, from data store 136 in order to execute reconfiguration in near real-time. Data store 136 may collect near real-time data from network elements, and accordingly, the output may be distributed to a device associated with a targeted user (also just referred to as “targeted user”).

With continued reference to FIG. 4, in an example use case, an image captured by a first unmanned aerial vehicle and video captured by a second unmanned aerial vehicle may be fused into a video, as disclosed herein. The disclosed fused video may be distributed among devices of targeted users in near real-time to provide a sky-view of local traffic or local environment to display. Example devices of targeted users may include autonomous vehicles (e.g., smart-connected cars) that may use this sky-view not only to display to a driver but also for intelligent driving (e.g., avoid obstacles or anticipate terrain). Output information which may be based on fused information may be distributed to local wireline or wireless devices (e.g., television or mobile phones). The decoupling of hardware and software in the RAN provides greater flexibility with the placement of computing operations at the network edge (e.g., gateways or base stations) in order to support future 5G, IoT, low latency services and network slicing.

Edge computing and radio access network (RAN) intelligent controller (MC) may be used for the disclosed subject matter for processing local environmental information and (re)distributing enhanced information. Edge computing is a distributed computing paradigm which brings computation and data storage closer to the location where it is needed, which may impact response times and bandwidth. Edge computing (EC) may bring real-time, high-bandwidth, low-latency access to latency-dependent applications, distributed at the edge of the network. Since edge computing is closer to the user equipment (e.g., mobile device 101, UV 102, or sensor 104) and applications, it allows for a new class of applications, and allows network operators to open their networks to a new ecosystem and value chain.

With continued reference to FIG. 4, edge device 107—edge device 109 may be integrated to the live and local awareness system as disclosed herein. In an example, the information disclosed in reference to FIG. 2 and FIG. 3 may be stored or processed on edge device 107—edge device 109 near a location of a user equipment that captured the information or near a site that frequently accesses the information. Storing or processing near the location may be triggered by reaching a threshold frequency of request for electronic media or other processing. Reconfiguration module 137 may receive information, such as latency or location, from data store 136 in order to execute near real-time reconfiguration of edge device 107—edge device 109. Reconfiguration module 137 may process information to obtain patterns to determine the use of edge devices. The information may include wireless or wired communication resources (e.g., bandwidth), latency, proximity to a data source (e.g., proximity to mobile device 101), quality of service, or compute resources of core, edge, or user equipment. Reconfiguration module 137 may use such information to determine whether or which edge device 107—edge device 109 are used, or the configuration of edge device 107—edge device 109, among other things. In an example, the method may provide for receiving performance information (e.g., latency between mobile devices and network devices) associated with the plurality of devices proximate to the location; detecting a change in the performance information that reaches a threshold; and based on reaching the threshold, providing instructions to redistribute to the plurality of edge devices, storage or processing of the fused information or the anonymized fused information.

Authentication, Authorization, and Accounting (AAA) module 130 of FIG. 4 may provide proper access to the framework for user devices (e.g., targeted users) requesting a service and provide required information (if any) for charging the user (e.g. # of requests, usage time). Via access, the location of interest (e.g., zip code, street name, etc.) and other required information may be selected on a user device. This information may be used to identify the location of interest, where the new local environmental information (e.g., electronic media associated with location and corresponding information) should be collected (for further processing and distribution) or queried from the data store 135. In addition, the user access profile module 139 stores the user access history (e.g. the time/location of requesting access, the local area of interest, etc.). This information, in addition to other auxiliary information (e.g. the user personal information) may be used for advertising purposes (if authorized) or malicious activity identification, among other things.

Wireless networks with the capability of automatic reconfiguration of the underlying software defined network, may play a significant role in facilitating the implementation of the disclosed subject matter. The disclosed subject matter may process local environmental information and (re)distribute enhanced information with low delay and high quality.

The collection of input information from external sources can be enabled via well-defined protocols and procedures. The collection of inputs from internal sources can also be done by collecting inputs from devices registered with a network service provider. In one scenario, legitimate users install a live or local environmental awareness application on their devices (e.g., mobile device 101 or mobile device 103). The live or local environmental awareness application may provide a gateway for: a) accessing the framework and accepting the request (note that, the request may be denied due to various reasons, e.g. lack of information for the region, . . . ) orb) responding to the request of the user device and providing the awareness for the local area of interest and display the content appropriately and in different formats (e.g., image, video, audio, text, or synthesized audio).

Below is an exemplary use case with reference to a mobile device (e.g., mobile phone). Images may be collected from mobile device 101 which has installed a live or local environmental awareness application for reconstructing visual scene (e.g., visual map) of local environments. In such scenario, a user with live or local environmental awareness application may provide electronic media from a local environment. The user can add more information about the scene (by adding text, audio, etc.) and the live or local environmental awareness application may further include the user location using GPS information on mobile device 101. These images from multiple user devices may be further processed at edge clouds for reconstructing a 2D or 3D visual scene of the environment. Machine-vision and image processing techniques for reconstructing high resolution images from low resolution images may be used in such scenario. Over time, this may be a relatively low-cost way to build a visual map of local environments. A visual map may be considered a map that includes images of much of the real-world environment, such as roads or store front images as they appeared at the time of image capture. This visual map may be incorporated into augmented or virtual reality. Note that information gathered through this process (e.g. user location) may be used in other applications or data, such as user localization. User localization information is an important data source for ubiquitous assistance in smart environments.

It is contemplated that some of the steps may occur at or near the local devices (e.g., mobile device 101). Information may be subsequently sent to server 105 based on a triggering event (e.g., an indication of anticipated car accident or a car accident based on an alert of air bag deployment). It is further contemplated that computer vision techniques, advanced signal/image/video processing techniques, machine learning, artificial intelligence, and deep-learning techniques may play a role in any one of the steps herein, such as in FIG. 2-FIG. 4. The steps and modules herein may be executed on one device or distributed over multiple devices.

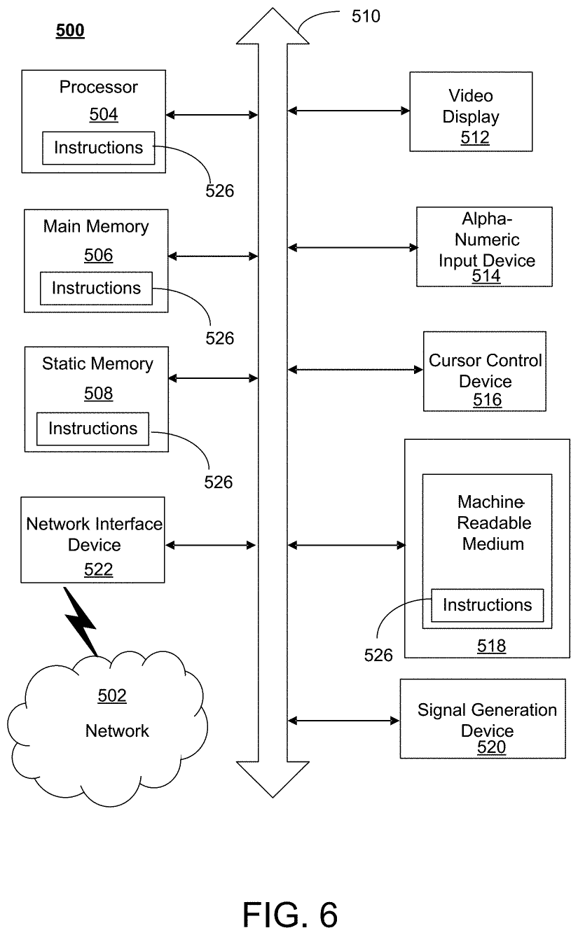

FIG. 5 is a block diagram of network device 300 that may be connected to or include a component of system 100. Network device 300 may include hardware or a combination of hardware and software. The functionality to facilitate telecommunications via a telecommunications network may reside in one or combination of network devices 300. Network device 300 depicted in FIG. 5 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 5 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may include a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 5) to allow communications between them. Each portion of network device 300 may include circuitry for performing functions associated with each respective portion. Thus, each portion may include hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may include a Wi-Fi finder, a two-way GPS chipset or equivalent, or the like, or a combination thereof.

Input/output system 306 of network device 300 also may include a communication connection 308 that allows network device 300 to communicate with other devices, network entities, or the like. Communication connection 308 may include communication electronic media. Communication electronic media typically embody computer-readable instructions, data structures, program modules or other data in a modulated data signal such as a carrier wave or other transport mechanism and includes any information delivery electronic media. By way of example, and not limitation, communication electronic media may include wired electronic media such as a wired network or direct-wired connection, or wireless electronic media such as acoustic, RF, infrared, or other wireless electronic media. The term computer-readable electronic media as used herein includes both storage electronic media and communication electronic media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may include a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may include executable instructions that, when executed by processor 302, cause processor 302 to effectuate operations to map signal strengths in an area of interest.

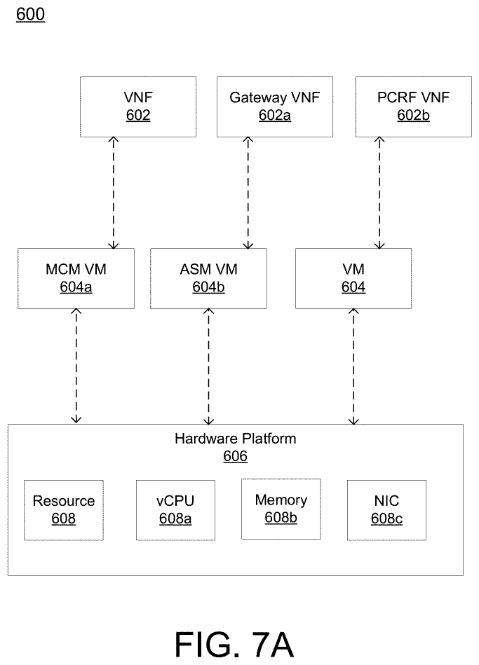

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, mobile device 102, mobile device 103, UV 102, sensor 104, server 105 and other devices of FIG. 1 and FIG. 4. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may include a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage electronic media.

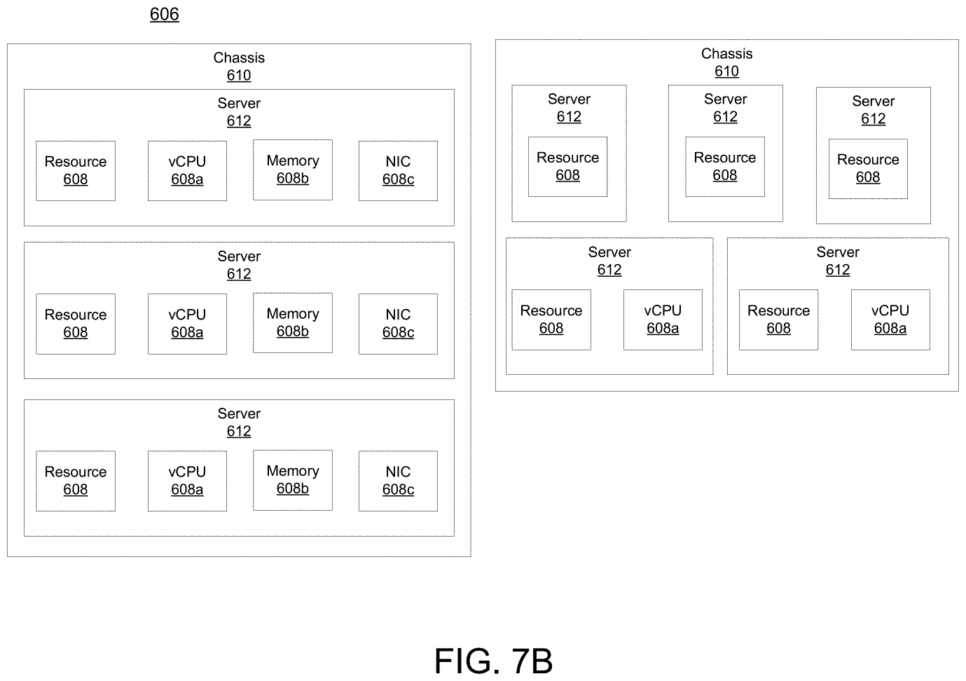

FIG. 7A is a representation of an exemplary network 600. Network 600 (e.g., network 106) may include an SDN. For example, network 600 may include one or more virtualized functions implemented on general purpose hardware, such as in lieu of having dedicated hardware for every network function. That is, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 7A illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 7A illustrates a management control module (MCM) VM 604a and an advanced services module (ASM) VM 604b. Additionally or alternatively, VMs 604 may include other types of VMs, such as a DEP VM (not shown). Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

While FIG. 7A illustrates resources 608 as collectively contained in hardware platform 606, the configuration of hardware platform 606 may isolate, for example, certain memory 608c from other memory 608c. FIG. 7B provides an exemplary implementation of hardware platform 606.

Hardware platform 606 may include one or more chassis 610. Chassis 610 may refer to the physical housing or platform for multiple servers or other network equipment. In an aspect, chassis 610 may also refer to the underlying network equipment. Chassis 610 may include one or more servers 612. Server 612 may include general purpose computer hardware or a computer. In an aspect, chassis 610 may include a metal rack, and servers 612 of chassis 610 may include blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chassis 610 may be communicatively coupled. Additionally or alternatively, chassis 610 may be communicatively coupled together (not shown) in any combination or arrangement.

The characteristics of each chassis 610 and each server 612 may differ. For example, FIG. 7B illustrates that the number of servers 612 within two chassis 610 may vary. Additionally or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to particular resources 608 may be constrained by one or more rules. For example, a first rule may require that resources 608 assigned to a particular VM 604 be on the same server 612 or set of servers 612. For example, if VM 604 uses eight vCPUs 608a, 1 GB of memory 608b, and 2 NICs 608c, the rules may require that all of these resources 608 be sourced from the same server 612. Additionally or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (that is, consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chassis 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have enough resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chassis 610 and servers 612 of hardware platform 606, and the individual resources 608 of each chassis 610 or server 612 (e.g., of a certain type), an integer programming problem may be formulated.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which live or local environmental awareness subject matter can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage electronic media having a concrete, tangible, physical structure. Examples of tangible storage electronic media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—live or local environmental awareness—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein. It is contemplated that the steps disclosed herein may be occur on one device (e.g., server 105) or distributed over a plurality of devices.

Methods, systems, and apparatuses, among other things, as described herein may provide for live or local environmental awareness. A method, system, computer readable storage medium, or apparatus may provide for receiving input information from a plurality of devices, wherein the input information may include audio, video, or images, wherein the plurality of devices may include sensor-enabled mobile phones, sensor-enabled unmanned vehicles, sensor-enabled manned vehicles, sensor-enabled autonomous vehicles, road traffic monitoring sensors, security cameras, or satellites (e.g., satellite images); fusing the input information from different sources, wherein the different sources may include at least one of the plurality of devices, wherein the fusing may be based on: registering images/videos, image or video segmentation and pattern recognition, adding audio (e.g., voice, music, or synthesized audios), labeling scenes, or incorporating auxiliary information by adding texts; anonymizing the fused input information, wherein the anonymizing may include replacing vehicles and people in scenes with appropriate symbols and replacing private areas with appropriate patterns or appropriate icons; and sending an alert about the anonymized fused input information, wherein the alert may include a link (e.g., URL) to the anonymized fused input information or at least an image, video, or text of at least some of the anonymized fused input information. The method, system, computer readable storage medium, or apparatus may pre-process the input information, wherein the pre-processing may include filtering input images, videos, or audio to enhance the quality, wherein standard techniques may be used for dealing with not a number (NaN) or missed values. NaN is a member of a numeric data type that can be interpreted as a value that is undefined or unrepresentable, especially in floating-point arithmetic. The receiving of one or more of the input information from one or more of the plurality of devices may be triggered by an indication of an emergency. In an example, an accident, call to 911, message to 911, or the like may trigger capture of info by end device or triggers obtaining already captured info from end devices. Fusing may include superimposing satellite images, aerial photography, mobile phone electronic media (photos, videos, or audio), or geographic information system data. All combinations in this paragraph and the following paragraph (including the removal or addition of steps) are contemplated in a manner that is consistent with the other portions of the detailed description.

Methods, systems, and apparatuses, among other things, as described herein may provide for live or local environmental awareness. A method, system, computer readable storage medium, or apparatus may provide for receiving information from a plurality of devices at a location during a period, the information including electronic media and location information, wherein the location information corresponds to where the electronic media was created; fusing the information from the plurality of devices, wherein the fusing includes superimposing the electronic media of the plurality of devices, wherein the electronic media includes images, video, or audio; anonymizing the fused information, wherein the anonymizing includes replacing people in the electronic media with an icon; receiving a request for an image, video, or audio associated with the location and the period; and in response to the request, providing the anonymized fused information corresponding to the location and the period. The location may be determined based on detecting an object in the electronic media and cross-referencing a previously known location of the object. The anonymized fused information may be provided to a visual mapping application. The request for the image, the video, or the audio may include an indication of an emergency at the location, wherein the emergency includes an assault or a traffic accident. The indication of the emergency may be based on a deployment of vehicular safety equipment, such as an air bag or specialized breaking, among other things. The method, system, computer readable storage medium, or apparatus may provide for receiving performance, location, or other measures from a plurality of devices; receiving analytics information based on the performance, location, or other measures (e.g., routing policies or other network information, such as latency, location of user equipment) from an analytics application; distributing the analytics information to a plurality of local edge devices; receiving from the plurality of local edge devices a periodic query of a change to the analytics information; when there is a change in the analytics information that reaches a threshold, redistributing, to the plurality of edge devices, the anonymized fused information corresponding to the location and the period. A method may provide for receiving performance (e.g., latency between mobile devices and network devices) or other information (e.g., routing policies or location of user equipment) from a plurality of devices; receiving analytics information based on the performance or other information; detecting a change to the analytics information; and when there is a change in the analytics information that reaches a threshold trigger (e.g., a pattern of latency and device location), providing instructions to redistribute, to the plurality of edge devices, storage or processing of the fused information or the anonymized fused information as disclosed herein. All combinations in this paragraph and the following paragraphs (including the removal or addition of steps) are contemplated in a manner that is consistent with the other portions of the detailed description.

Methods, systems, and apparatuses, among other things, as described herein may provide for live or local environmental awareness. A method, system, computer readable storage medium, or apparatus may provide for receiving an indication of an emergency at a location during a period, wherein the indication of the emergency may be based on an indication of a communication to an emergency phone number (e.g., 911 or security guard), an indication of a significant accident (e.g., air bag deployment indication), an indication of anticipated accident (e.g., from a vehicle), or an indication of a crime (e.g., computer vision detects a robbery or assault based on video from security camera). Based on the indication of the emergency at the location, determining a plurality of devices proximate to the location (e.g., within 200 feet or within a viewing angle of the location), wherein the information may be marked at a high priority for processing electronic media or having electronic media traverse a communications network. Based on the indication of the emergency at the location, receiving electronic media and corresponding information from a plurality of devices proximate to the location (wherein the receiving of electronic media is based on providing instructions to the plurality of devices to share electronic media and corresponding information during the period at the location). Based on the indication of the emergency at the location, providing instructions to record electronic media (automatically) to at least a subset of the plurality of the devices and subsequently obtaining the recorded electronic media and corresponding recorded electronic media information in response. The method, system, computer readable storage medium, or apparatus may fuse the electronic media, the corresponding information, the recorded electronic media, and the corresponding recorded electronic media information. The method, system, computer readable storage medium, or apparatus may generate a reconstruction (e.g., fused electronic media which may be combined with simulations that fill in any blanks)) of the period associated with the emergency. The method, system, computer readable storage medium, or apparatus may send the reconstruction to a device (e.g., insurance company related device, public safety related device, injured or other user related device). Public safety may include police, fire, hospitals, medical transport (e.g., emergency medical technician (EMT), or the like. All combinations in this paragraph and the following paragraphs (including the removal or addition of steps) are contemplated in a manner that is consistent with the other portions of the detailed description.

Methods, systems, and apparatuses, among other things, as described herein may provide for live or local environmental awareness. A method, system, computer readable storage medium, or apparatus may provide for receiving information from a plurality of devices during a period, the information comprising electronic multimedia and location information, wherein the location information corresponds to a location of a source device of the plurality of devices at which the electronic multimedia was created, the location being proximate to the apparatus; fusing the information from the plurality of devices; anonymizing the fused information, wherein the anonymizing includes replacing people in the electronic media with an icon; receiving a request for an image, video, or audio associated with the location and the period; and in response to the request, providing the anonymized fused information corresponding to the location and the period. The apparatus being proximate to the location is based, at least in part, on a latency requirement, the latency requirement comprising a maximum latency for receiving the information at the apparatus from the source device. The latency requirement may be a threshold (e.g., less than 20 ms). The apparatus being proximate to the location may be further based, at least in part, on a distance requirement, the distance requirement comprising a maximum distance between the apparatus and the source device. The distance requirement may be a threshold (e.g., 3000 meters). All combinations in this paragraph and the following paragraphs (including the removal or addition of steps) are contemplated in a manner that is consistent with the other portions of the detailed description.

Methods, systems, and apparatuses, among other things, as described herein may provide for live or local environmental awareness. A method, system, computer readable storage medium, or apparatus may provide for receiving information from a plurality of devices at a location during a period, the information including electronic media, sensor information, time information, or location information, wherein the location information corresponds to where the electronic media or sensor information was created or monitored, wherein the time information indicates when the electronic media or sensor information was created or monitored; fusing the information from the plurality of devices, wherein the fusing includes superimposing the electronic media of the plurality of devices and incorporating sensor information or auxiliary information from other sources, wherein the electronic media includes images, video, or audio; anonymizing the fused information, wherein the anonymizing including replacing private or sensitive information (e.g., faces of people, license plates, blood, obscene language, obscene acts, private conversations, or medical-related sensor information), in the electronic media with an appropriate symbol, pattern, icon, or other substitute (e.g., muted audio, blurred images, etc.); receiving a request for an image, video, sensor information, or audio associated with the location and the period; and in response to the request, providing the anonymized fused information corresponding to the location and the period. The anonymizing of the fused information may include only replacing a portion of a live object (e.g., face, hand, tattoo) in the electronic media with a representative icon. The location may be determined based on detecting an object in the electronic media and cross-referencing a previously known location of the object. The anonymized fused information may be provided to a visual mapping application. The request for the image, the video, or the audio may include an indication of an emergency at the location, wherein the emergency includes an assault or a traffic accident. The indication of the emergency may be based on a deployment of vehicular safety equipment, such as an air bag or specialized breaking, among other things. The anonymized fused information is appropriately visualized in different formats. The request may determine the format of output and details incorporated in output, for example, enabling audio or text added to images. The fusing further including incorporating certain types of sensor information (e.g., motion) and auxiliary information, such as whether audio, video, images, text, etc. The request may be from a 3rd party user and the outputs may be transferred or streamed to 3rd party users. The anonymized fused information is included in a video broadcast, such as television or live internet-based broadcast. All combinations in this paragraph and the previous paragraphs (including the removal or addition of steps) are contemplated in a manner that is consistent with the other portions of the detailed description.

What is claimed:

1. An apparatus comprising:
a processor; and
memory coupled with the processor, the memory storing executable instructions that when executed by the processor cause the processor to effectuate operations comprising:
receiving information from a plurality of devices during a period, the information comprising electronic multimedia and location information, wherein the location information corresponds to a location of a source device of the plurality of devices at which the electronic multimedia was created, the location being proximate to the apparatus;
fusing the information from the plurality of devices;
anonymizing the fused information, wherein the anonymizing comprises replacing a live object in the electronic multimedia with a representative icon;
receiving a request for an image, a video, or audio associated with the location and the period; and
in response to the request, providing the anonymized fused information corresponding to the location and the period.

2. The apparatus of claim 1, the operations further comprising storing or processing the information on an edge device proximate to the location.

3. The apparatus of claim 1, the operations further comprising:
receiving performance information associated with the plurality of devices proximate to the location;
detecting a change in the performance information that reaches a threshold; and
based on reaching the threshold, providing instructions to redistribute to a plurality of edge devices, storage or processing of the fused information or the anonymized fused information.

4. The apparatus of claim 1, wherein the apparatus being proximate to the location is based, at least in part, on a latency requirement, the latency requirement comprising a maximum latency for receiving the information at the apparatus from the source device.

5. The apparatus of claim 4, wherein the apparatus being proximate to the location is further based, at least in part, on a distance requirement, the distance requirement comprising a maximum distance between the apparatus and the source device.

6. The apparatus of claim 1, wherein the location is determined based on detecting an object in the electronic multimedia and cross-referencing a previously known location of the object.

7. The apparatus of claim 1, wherein the request for the image, the video, or the audio comprises an indication of an emergency at the location, wherein the indication of the emergency is based on a deployment of safety equipment of a vehicle.

8. A method comprising:
receiving, by a processor, information from a plurality of devices during a period, the information comprising electronic multimedia and location information, wherein the location information corresponds to a location of a source device of the plurality of devices at which the electronic multimedia was created, the location being proximate to an apparatus;
fusing, by the processor, the information from the plurality of devices;
anonymizing, by the processor, the fused information, wherein the anonymizing comprises replacing a live object in the electronic multimedia with a representative icon;
receiving, by the processor, a request for an image, a video, or audio associated with the location and the period; and
in response to the request, providing, by the processor, the anonymized fused information corresponding to the location and the period.

9. The method of claim 8, wherein the anonymized fused information is provided to a visual mapping application.

10. The method of claim 8, the operations further comprising storing or processing the information on an edge device proximate to the location.

11. The method of claim 8, wherein the apparatus being proximate to the location is based, at least in part, on a latency requirement, the latency requirement comprising a maximum latency for receiving the information at the apparatus from the source device.

12. The method of claim 11, wherein the apparatus being proximate to the location is further based, at least in part, on a distance requirement, the distance requirement comprising a maximum distance between the apparatus and the source device.

13. The method of claim 8, wherein the location is determined based on detecting an object in the electronic multimedia and cross-referencing a previously known location of the object.

14. The method of claim 8, wherein the request for the image, the video, or the audio comprises an indication of an emergency at the location, wherein the indication of the emergency is based on a deployment of safety equipment of a vehicle.

15. A system comprising:
one or more processors; and
memory coupled with the one or more processors, the memory storing executable instructions that when executed by the one or more processors cause the one or more processors to effectuate operations comprising:
receiving information from a plurality of devices during a period, the information comprising electronic multimedia and location information, wherein the location information corresponds to a location of a source device of the plurality of devices at which the electronic multimedia was created, the location being proximate to an apparatus;
fusing the information from the plurality of devices;
anonymizing the fused information, wherein the anonymizing comprises replacing a live object in the electronic multimedia with a representative icon;
receiving a request for an image, a video, or audio associated with the location and the period; and
in response to the request, providing the anonymized fused information corresponding to the location and the period.

16. The system of claim 15, the operations further comprising storing or processing the information on an edge device proximate to the location.

17. The system of claim 15, wherein the apparatus being proximate to the location is based, at least in part, on a latency requirement, the latency requirement comprising a maximum latency for receiving the information at the apparatus from the source device.

18. The system of claim 17, wherein the apparatus being proximate to the location is further based, at least in part, on a distance requirement, the distance requirement comprising a maximum distance between the apparatus and the source device.

19. The system of claim 15, wherein the request for the image, the video, or the audio comprises an indication of an emergency at the location.

20. The system of claim 15, the operations further comprising:
receiving performance information associated with the plurality of devices proximate to the location;
detecting a change in the performance information that reaches a threshold; and
based on reaching the threshold, providing instructions to redistribute to a plurality of edge devices, storage or processing of the fused information or the anonymized fused information.
